(19) United States
(12) Patent Application Publication
(10) Pub. No.: US 2002/0133604 A1
(43) Pub. Date: Sep. 19, 2002

(54) Instruction set file generation for online account aggregation

(76) Inventors: Alok Khanna, Mountain View, CA (US); Shekhar Mahadevan, Fremont, CA (US); Shrirang Nene, Fremont, CA (US); Rajiv Saxena, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/087,623

(22) Filed: Mar. 1, 2002

Related U.S. Application Data
(60) Provisional application No. 60/277,343, filed on Mar. 19, 2001.

(51) Int. Cl. G06F 15/16; G06F 12/14; H04L 9/32; G06F 11/30

(52) U.S. Cl. 709/229; 713/200

(57) ABSTRACT

In one embodiment, a method comprises receiving a request for logging into an account on a web site from a web browser application. The method also comprises recursively performing the following until a user is logged into the account for the web site: saving the request into an instruction set file; transmitting the request for logging into the web site to a server that includes the web site; receiving a response from the web site; and transmitting a request that is in response to the response from the web site.

### CROSS REFERENCE TO RELATED APPLICATION

This application claims the benefit of U.S. provisional patent application No. 60/277,343 entitled “Method and Apparatus for Online Account Consolidation,” filed Mar. 19, 2001.

### FIELD OF THE INVENTION

The invention relates to client-server networks. More specifically, the invention relates to a method and apparatus for online account aggregation across such networks.

### BACKGROUND OF THE INVENTION

The Internet and wireless revolution are transforming the way consumers bank, shop and manage their personal activities. Moreover, the Internet and wireless revolution are also changing the way individuals are conducting their business activities. Such consumers and business individuals are increasingly interacting with vendors online rather than by making phone calls and visiting stores.

However, as consumers and business individuals establish accounts online, a new problem emerges. These persons now have to remember login information, such as username and password, for each account. Moreover, these persons must navigate through multiple pages of a web site before finding the information for which they are looking. For example, if the person is logging into their email account, they typically encounter a login screen followed by the inbox screen showing the new messages. Additionally, the person must remember to proactively check time-sensitive accounts, which could include, for example, financial-related information. A given person may also have multiple email accounts, multiple financial accounts as well as multiple accounts across different online stores. Accordingly, this individual must remember the names of the different web sites, account identification, username and/or password for each of the different accounts.

Moreover, such individuals will no longer be satisfied with accessing these accounts just from their personal computers (PCs). They will want access from personal digital assistants (PDAs), mobile phones, Internet appliances and from other such devices for accessing of such online account information.

### SUMMARY OF THE INVENTION

A method and apparatus for instruction file set generation for online account aggregation are described. In one embodiment, a method comprises receiving a request for logging into an account on a web site from a web browser application. The method also comprises recursively performing the following until a user is logged into the account for the web site: saving the request into an instruction set file; transmitting the request for logging into the web site to a server that includes the web site; receiving a response from the web site; and transmitting a request that is in response to the response from the web site.

### BRIEF DESCRIPTION OF THE DRAWINGS

Embodiments of the invention may be best understood by referring to the following description and accompanying drawings which illustrate such embodiments. In the drawings:

FIG. 1 is block diagram illustrating a system, according to one embodiment of the invention.

FIG. 2 is a block diagram illustrating one of servers 104a-i according to one embodiment of the invention.

FIG. 3 is a flowchart illustrating the automatic login process according to one embodiment of the invention;

FIG. 4 illustrates a page shown to the user once they are logged into web site 214, according to one embodiment of the invention.

FIG. 5 illustrates an example instruction set for a given web site, according to one embodiment of the invention.

FIG. 6A illustrates the interactions among client 102, server 104 and destination site 108 for a proxy auto login process for online account aggregation, according to one embodiment of the invention.

FIG. 6B illustrates the interactions among client 102, server 104 and destination site 108 for a proxy auto login process for online account aggregation, according to another embodiment of the invention.

FIG. 7 illustrates a block diagram of a proxy component in conjunction with a client 102 and a server 104 for the generation of an instruction set for a given web site, according to one embodiment of the invention.

FIG. 8 is a flowchart illustrating the generation of a set of instructions for a given web site, according to one embodiment of the invention.

FIG. 9 illustrates a block diagram of a screen for client 102 during the generation of a rule file employed during automatic reads, according to one embodiment of the invention.

FIG. 10 is a flowchart illustrating the generation of a rule file for a given web site, according to one embodiment of the invention.

FIG. 11 illustrates a web page from which data can be extracted, according to one embodiment of the invention.

FIG. 12 is a flowchart illustrating the incorporation of the rules files, according to one embodiment of the invention.

### DETAILED DESCRIPTION

A method and apparatus for instruction file set generation for online account aggregation are described. In the following description, for purposes of explanation, numerous specific details are set forth in order to provide a thorough understanding of the present invention. It will be evident, however, to one skilled in the art that the present invention may be practiced without these specific details.

### SYSTEM OPERATION

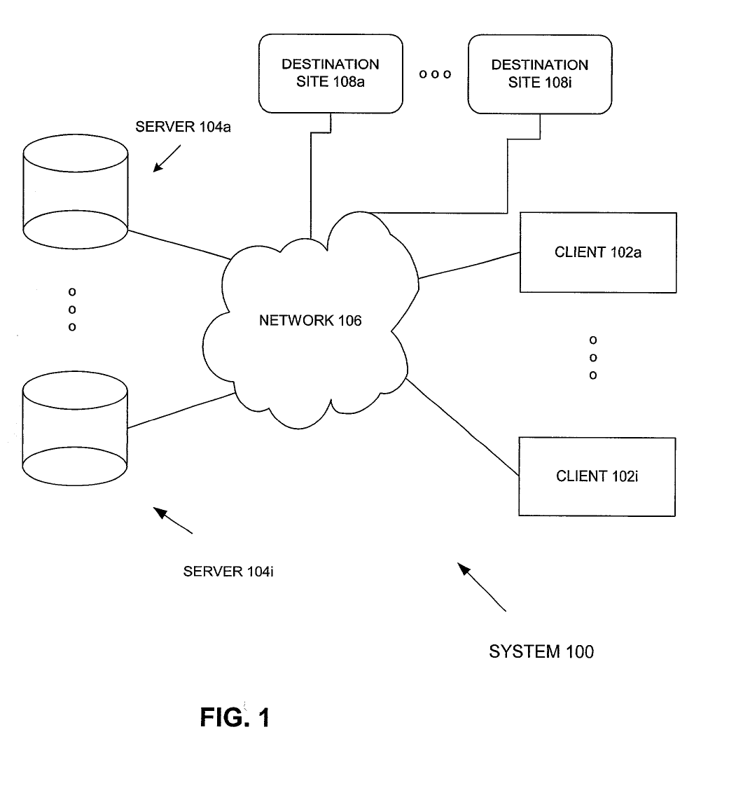

FIG. 1 is block diagram illustrating a system, according to one embodiment of the invention. In particular, FIG. 1 illustrates system 100 that includes clients 102a-i, servers 104a-i and destination sites 108a-i, which are coupled together through network 106. Clients 102a-i can be one to any number of different computing devices, such as desktop or notebook computers or wireless devices (e.g., PDAs). Additionally, servers 104a-i can include one to any number of such servers in system 100. Destination sites 108a-i can be one of a number of different web sites that can include online accounts (as will be described in more detail below).

While different embodiments of the present invention could have different types of communication protocols between clients 102a-i, servers 104a-i and destination sites 108a-i, in an embodiment, the communication protocol between clients 102a-i, servers 104a-i and destination sites 108a-i is the HyperText Transfer Protocol (HTTP). Moreover, in one such embodiment, the communication protocol is upgraded to Secure-HyperText Transfer Protocol (HTTPS) to allow for increased security between clients 102a-i, servers 104a-i and destination sites 108a-i.

In one embodiment, network 106 is a local area network (LAN). In another embodiment, network 106 is a wide area network (WAN). In one such embodiment, network 106 is the Internet. Further, network 106 can be a combination of different networks that provide communication between servers 104a-i and clients 102a-i. Moreover, to allow for increased security regarding the communications between clients 102a-i and servers 104a-i, virtual private networks (VPNs) within network 106 can be established between a given client 102 and a given server 104.

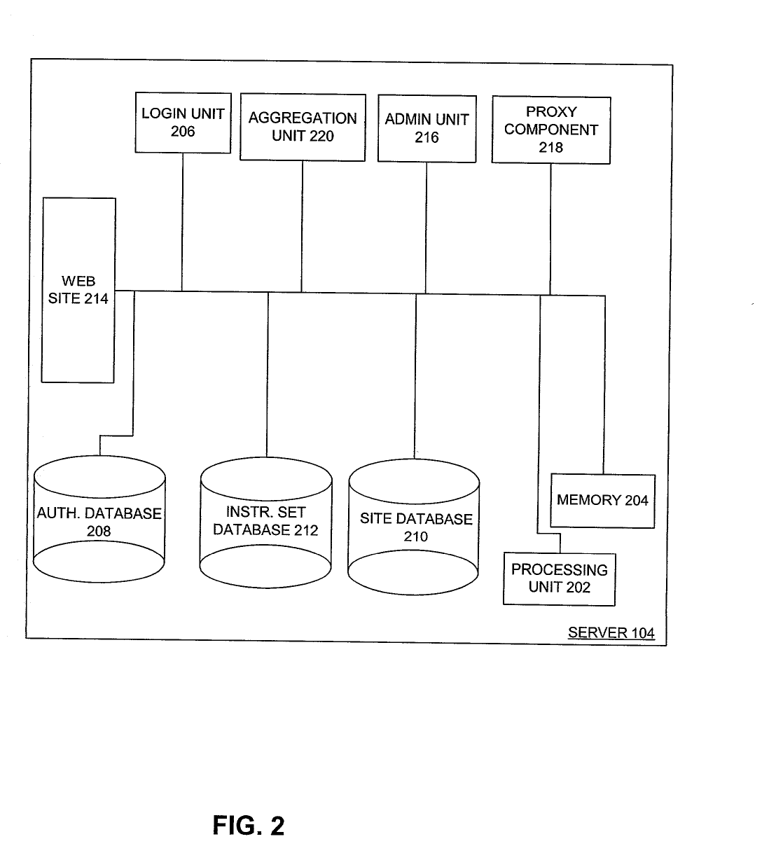

FIG. 2 is a block diagram illustrating one of servers 104a-i (hereinafter “server 104), according to one embodiment of the invention. As shown, server 104 includes processing unit 202, memory 204, login unit 206, aggregation unit 220, administration unit 216, proxy component 218, authentication database 208, site database 210, instruction set database 212 and web site 214, which are coupled together. Processing unit 202 can be any of a variety of different types of processing units. Moreover, memory 204 can be a variety of different types of memories. In one embodiment, memory 204 is a random access memory (RAM). However, embodiments of the invention are not so limited as memory 204 can be other type of memory.

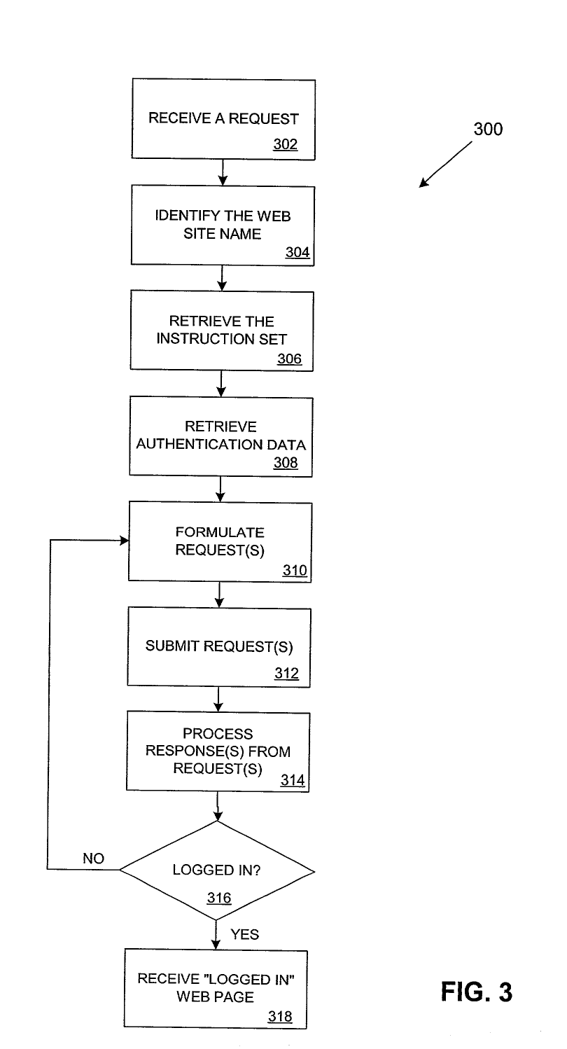

In one embodiment, login unit 206, aggregation unit 220, administration unit 216 and proxy component 218 are software applications that can reside in memory 204 and processing unit 202 during its execution in processing unit 202. However, embodiments of the present invention are not so limited, as However, embodiments of the present invention are not so limited, as login unit 206, aggregation unit 220, administration unit 216 and proxy component 218 can be different types of hardware (such as digital logic) executing the processing described therein (which is described in more detail below). Operations of login unit 206 will be described in more detail below in conjunction with FIG. 3.

Authentication database 208, site database 210 and instruction set database 212 can be any type of database for the storage of data. Examples of such databases include, but are not limited to, relational databases or object-oriented databases. Moreover, authentication database 208, site database 210 and instruction set database 212 are described and illustrated as separate storage entities. However, this is for the sake of clarity and not by way of limitation, as such databases can be stored in various storage entities. For example, authentication database 208, site database 210 and instruction set database 212 can be stored as a single storage entity.

Authentication database 208 includes database entries associated with a set of credentials for individual users of website 214. In one embodiment, these database entries are encrypted. Additionally, such entries include, but are not limited to, user information with regard to the logging into different web sites residing on servers 104a-i. In an embodiment, this user information can include a username or user identification and password for the different web sites. Examples of types of such web sites include email accounts, financial accounts and online store accounts. However, embodiments of the present invention are not limited to the above-described examples, as any other type of account-based web site can be incorporated into embodiments of the present invention. Accordingly, each user of web site 214 can have one to any number of database entries within authentication database 208, depending on the number of web sites the user is incorporating into their usage of web site 214, which is described in more detail below.

Site database 210 includes database entries for the different web sites that users of web site 214 can incorporate into their usage of web site 214. Moreover, instruction set database 212 includes database entries for a set of unique instructions associated with each of the different web sites that users can incorporate into their usage of web site 214. The generation and usage of such instruction sets are described in more detail below.

### AUTOMATIC LOGIN PROCESS

System 100 and login unit 206 will now be described in more detail in accordance with the flowchart illustrated in FIG. 3. In particular, FIG. 3 is a flowchart illustrating the automatic login process according to one embodiment of the invention. FIG. 3 illustrates method 300 that commences with the receipt of a request to perform an automatic (auto) login for the user of web site 214 into a given web site whose address is stored in site database 210, at process block 302.

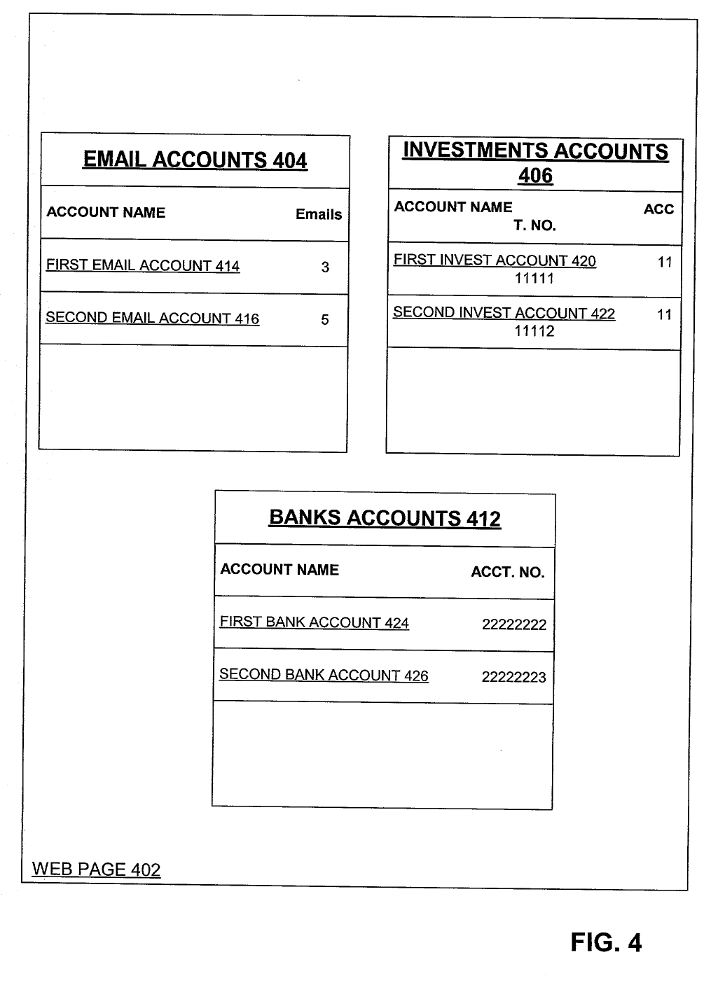

FIG. 4 illustrates one embodiment of how the user of web site 214 conveys such a request. In particular, FIG. 4 illustrates a web page shown to the user once they are logged into web site 214, according to one embodiment of the invention. As shown, FIG. 4 illustrates web page 402 that includes email accounts 404, investment accounts 406 and bank accounts 412. Moreover, email accounts 404 include first email account 414 and second email account 416, while investment accounts 406 includes first investment account 420 and second investment account 422. Additionally, bank accounts 412 include first bank account 424 and second bank account 426. The accounts illustrated in FIG. 4 are by way of example and not by way of limitation as other types of accounts can be incorporated into embodiments of the present invention. For example, the user could also include a calendar account, which is a web site having an online calendar. In further example, the user could have stock accounts and/or credit card accounts.

In an embodiment, first and second email accounts 414-416, first and second investment accounts 420-422, and first and second bank accounts 424-426 are hyperlink names which are associated with different web site addresses and when activated (e.g., being selected or clicked) pressed or selected transfer the user to the particular web site address associated with the given hyperlink name.

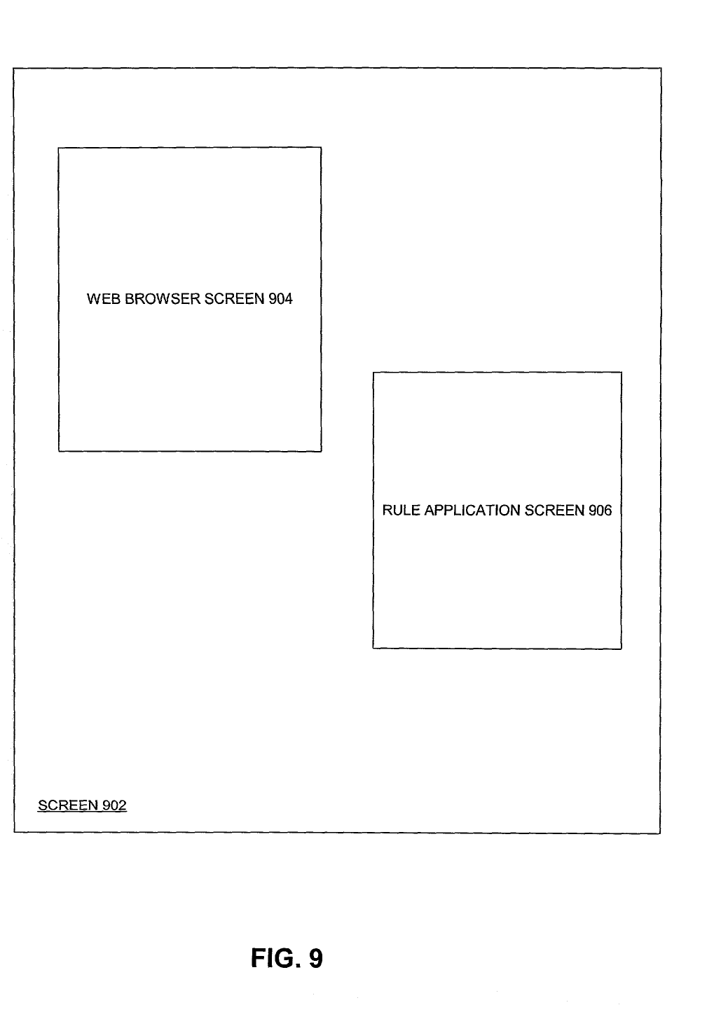

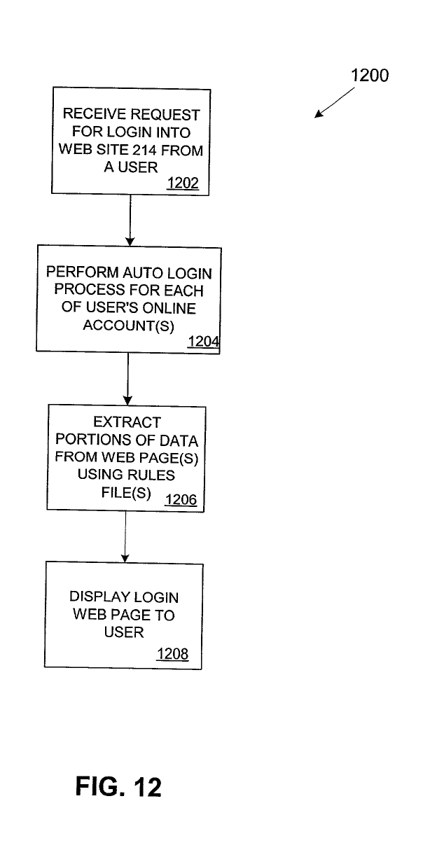

Moreover in an embodiment, web page 402 can include portions of relevant data extracted from each of the different account web sites. For example, as illustrated, for first email account 414 and second email account 416, there is the number of new messages (3 and 5, respectively) in their accounts. Additionally, the investment and bank accounts include the account number associated with each of these accounts. These are by way of example and not by way of limitation, as other types of relevant data for the given web sites can be included in web page 402. For example, the accounts for investment accounts 406 and bank accounts 412 could include the current balance of such accounts. The retrieval of this relevant data from the different account web sites will be described in more detail below in conjunction with FIGS. 9-11. Moreover, a more detailed description of the extraction and display of this relevant data is provided below in conjunction with FIG. 12.

Returning to FIG. 3, at process block 302, when the user selects one of the hyperlinks for a given account, this request is sent to login unit 206, which receives the request. Upon receipt of this request, login unit 206 identifies the web site associated with the selected hyperlink, at process block 304. In particular, login unit 206 identifies the associated web site by searching site database 210 for this associated web site based on the hyperlink, as each hyperlink includes a database entry within site database 210. Such a database entry includes the corresponding web site name and address.

Additionally, login unit 206 retrieves an instruction set from instruction set database 212 associated with the given web site to which the user desires to be auto logged into, at process block 306. Accordingly, in an embodiment, each web site stored in site database 210 includes a corresponding instruction set stored in instruction set database 212. An instruction set is defined to include a series of requests that correspond to responses from the associated web site and to be sent thereto in order to allow for the auto login for the user therein. In an embodiment, there are multiple instructions in an instruction set in order to enable the auto login process.

In particular for a typical manual login operation into a web site by a user, such a web site may require a series of requests from the user in order for the user to be logged into the web site. A user may, for example, be required to traverse a number of pages, while entering in different information into such pages during the course of the login process. For example, an initial web page may be a welcome page, which is returned to the user. In response, the user may be required to select a particular button on the welcome web page in order to receive the login page (e.g., a login button). Accordingly, this button selection by the user is transmitted back to the web site. In turn, the web site returns the login page. The user is then allowed to enter their username and password into specified fields on the login page. Subsequent to entering the username and password, the user typically selects another button, causing this user-entered data to be transmitted back to the web site. The user is then logged into the web site. Accordingly, the web site typically returns a page specific to the user indicating that the user is logged therein. For example, for an email web site, the user receives the inbox web page showing their new emails.

The prior description of a login process is by way of example and not by way of limitation, as there can be variances in the order of transfer of data as well as the types of data exchanged between the user and the web site. For example, the web site may additionally require a cookie from the user during the login process. A cookie, as is known in the art, is data generated by the web site and/or server and transmitted to the client for storage therein. Accordingly, these cookie files provide a tracking mechanism for the preferences and usage patterns of the client to allow for the customization of web pages for a given client. Clients can then transmit these cookie files back to the web site each time the client communicates with the web site to allow for this customization. As illustrated, in order to login into a given web site multiple requests and responses between the user and the web site may be required.

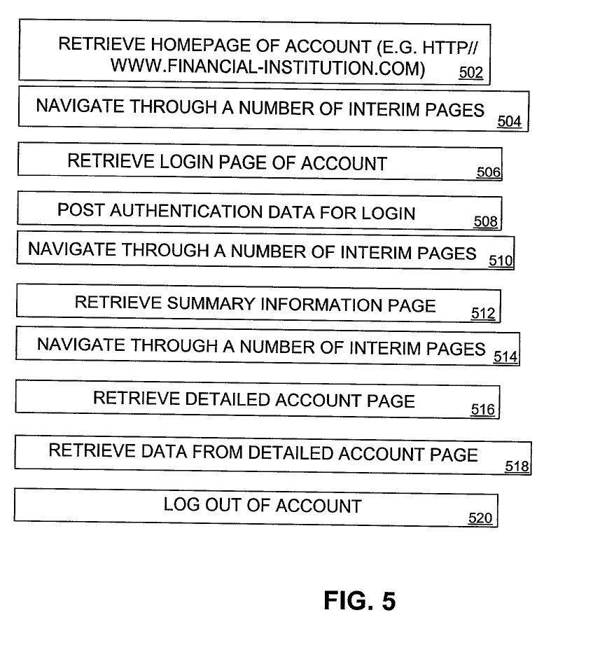

Therefore, the different instruction sets for different associated web sites stored in instruction set database 212 includes the requests that the given web site is expecting during the course of the login process for the user, thereby allowing for an auto login into a given web site. FIG. 5 illustrates an example instruction set for a given web site, according to one embodiment of the invention. As shown, the instruction set within FIG. 5 includes instruction 502, wherein the homepage for a given account is retrieved. Instruction 504 is representative of a number of instructions that can be included in an instruction set, wherein a number of interim pages are navigated in order to locate the login page. For example, the homepage may not include a direct hyperlink to a login page, but rather a link to a page that includes a link to the login page. Instruction 506 represents instructions employed in retrieving the login page of the account. Instruction 508 represents instructions used to post authentication data for the login (such as username and password) back to destination site 108. Instruction 510 represents instructions to navigate through a number of interim pages in order to locate the summary information page for the account.

Instruction 512 represents the instructions to retrieve the summary information page. An example of a summary information page could include a page that lists a number of different accounts for the same login account. For example, for a bank account, a login account could be associated with a savings and a checking account. Accordingly, the summary information page may include the account balances for each account.

Instruction 514 represents instructions to navigate through a number of interim pages in order to locate a detailed account page. Instruction 516 represents the instructions to retrieve the detailed account page. Returning to the example of a bank account, a detailed account page may include detailed entries related to deposits and withdraws for the checking account. Instruction 518 represents instructions to retrieve data from the detailed account page using a rules file, which is described in more detail below. Instruction 520 represents instructions to log out of the account.

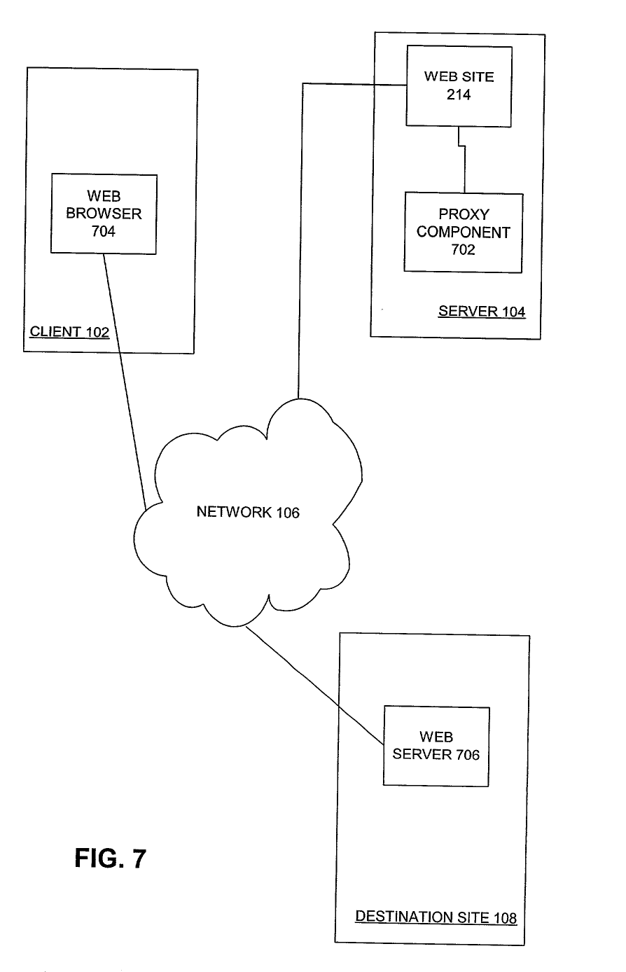

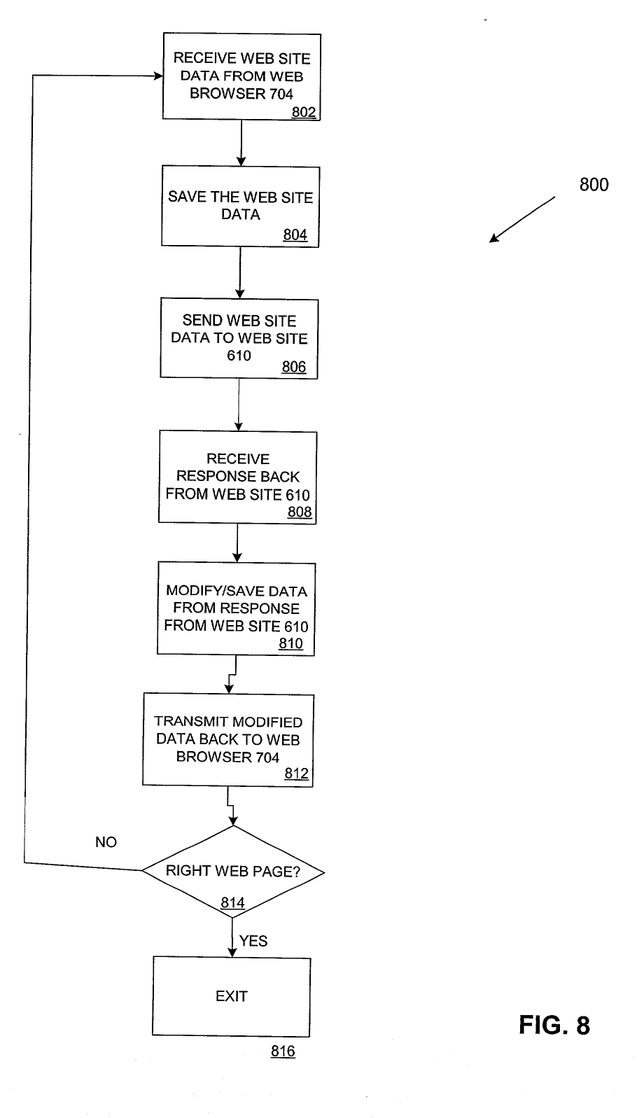

The number and type of instructions illustrated in FIG. 5 are by way of example. Other instruction sets may not include every instruction shown in FIG. 5, while other instruction sets may include other instructions not shown in FIG. 5. The generation of these different instruction sets is described in more detail below in conjunction with FIGS. 7-8.

Returning to FIG. 3, login unit 206 also retrieves authentication for the particular user for the given web site from authentication database 208, at process block 308. In particular, authentication database 208 includes a database entry for each user of web site 214. In an embodiment, each of these database entries includes the username and verification data (e.g., a password) for all of the different web sites that the user accesses from web site 214. Therefore, for a given user, if such a user is accessing 100 different online accounts through web site 214, the database entry stored in authentication database 208 for this user could include 100 different entries associated with the 100 different online accounts. Accordingly, login unit 206 retrieves the authentication information for this particular user for this particular web site from authentication database 208.

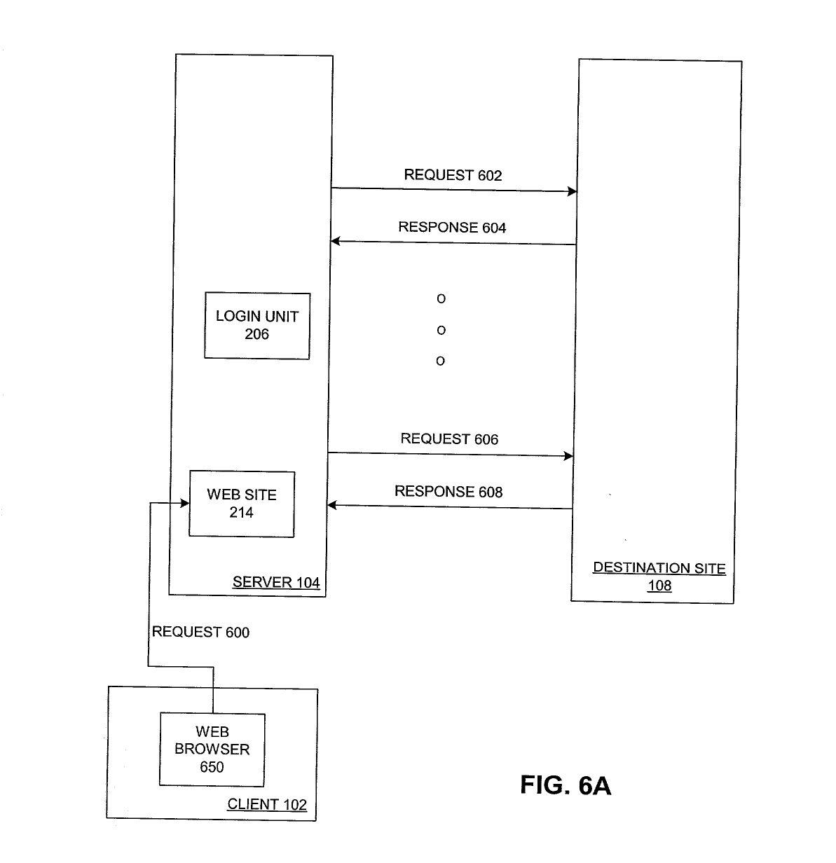

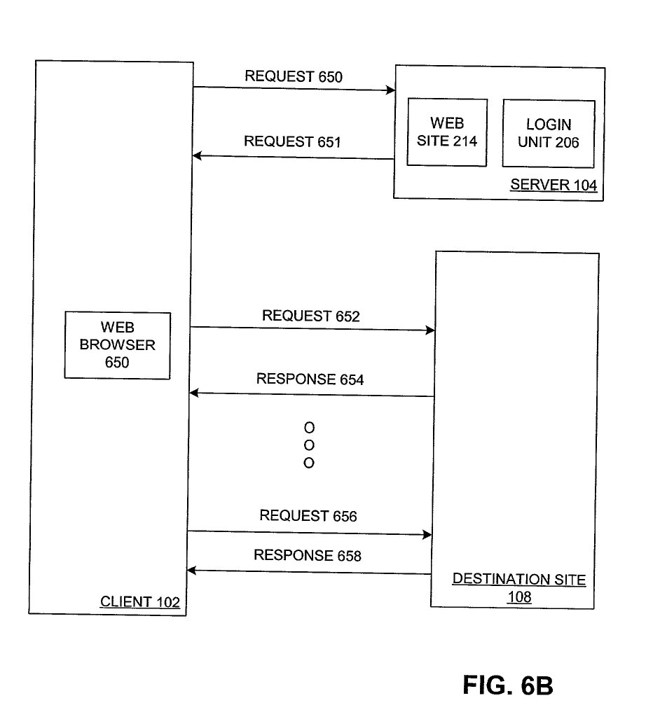

Login unit 206 formulates one to a number of requests to be transmitted to the given web site by incorporating this retrieved authentication data along with the retrieved web site into the retrieved instruction set, at process block 310. Login unit 206 begins one to any number of communications with the given web site to which the user of client 102 desires to log in by submitting the request(s), at process block 312. Moreover, login unit 206 processes the responses to such requests coming back from the web site, at process block 314. Login unit 206 determines if the user of client 102 is logged in, at process decision block 316. In particular, the following description in conjunction with FIG. 6 will help illustrate embodiments of process blocks 310-316.

FIG. 6A illustrates the interactions among client 102, server 104 and destination site 108 for a proxy auto login process for online account aggregation, according to one embodiment of the invention. In an embodiment, this process is initiated by a user of client 102 who desires to aggregate information from destination site 108. Client 102 initiates this aggregation via request 600 to web site 214 (located on server 104). As will be described below, acting as a proxy between client 102 and destination site 108, server 104 automatically logs on to destination site 108. In an embodiment, login unit 206 (within server 104) transmits request 602 to destination site 108. Request 602 is based on a first instruction in the instruction set having the incorporated data therein. In an embodiment, request 602 is a request to receive the initial web page from destination site 108 (e.g., a welcome page).

In turn, destination site 108 transmits response 604 back to server 104. In one such embodiment, response 604 is the initial web page for destination site 108. However, embodiments of the present invention are not so limited, as destination site 108 can transmit back other type of responses. For example, destination site 108 could transmit back the initial web page along with a cookie associated with destination site 108. In a further example, response 604 could include a redirect to another web page and/or an update to an already existing cookie file. Login unit 206 determines whether the auto login is complete upon receipt of the response back from destination site 108. In one such embodiment, the auto login is complete when the response to the last instruction request in the instruction set has been received.

As shown by request 606 and response 608, server 104 and destination site 108 can continue transmitting one to a number of requests and responses there between until client 102 reaches the desired web page on destination site 108. Accordingly, in an embodiment of the present invention, each instruction in a given instruction set is associated with a given request to be transmitted back to destination site 108. Different web sites require different communications in order to allow for server 104 to login to destination site 108. For example, client 102 may be required to transmit a cookie in one request followed by a user name and password in an additional request.

Depending on the web site, there can be one to any number of instructions in a given instruction set. A given instruction set includes all of the necessary requests in order to login client 102 into destination site 108. The generation of the instruction set is described in more detail below in conjunction with FIGS. 7 and 8. Once the last instruction in the instruction set is transmitted to the web site, a web page is transmitted back to the user indicating that the user is logged into the web site, at process block 318. For example, if the web site is an email web site, this web page could be a display of the inbox showing the new emails for this email account.

FIG. 6B illustrates the interactions among client 102, server 104 and destination site 108 for a proxy auto login process for online account aggregation, according to another embodiment of the invention. In an embodiment, this process is initiated by a user of client 102 who desires to aggregate information from destination site 108. Client 102 initiates this aggregation via request 650 to web site 214 (located on server 104). Login unit 206 transmits response 651 back to client 102. In an embodiment, response 651 comprises an instruction set file that enables client 102 to auto login to destination site 108 to be executed on web browser 650.

Accordingly, request 652 is based on a first instruction in the instruction set having the incorporated data therein. In an embodiment, request 652 is a request to receive the initial web page from destination site 108 (e.g., a welcome page).

In turn, destination site 108 transmits response 654 back to client 102. In one such embodiment, response 654 is the initial web page for destination site 108. However, embodiments of the present invention are not so limited, as destination site 108 can transmit back other type of responses. For example, destination site 108 could transmit back the initial web page along with a cookie associated with destination site 108. In a further example, response 654 could include a redirect to another web page and/or an update to an already existing cookie file. Based on whether the instructions within the instruction set file are complete, client 102 determines whether the auto login is complete upon receipt of the response back from destination site 108. Accordingly, in one such embodiment, the auto login is complete when the response to the last instruction request in the instruction set has been received.

As shown by request 656 and response 658, client 102 and destination site 108 can continue transmitting one to a number of requests and responses there between until client 102 reaches the desired web page on destination site 108. Accordingly, in an embodiment of the present invention, each instruction in a given instruction set is associated with a given request to be transmitted back to destination site 108. Different web sites require different communications in order to allow for client 102 to login to destination site 108. For example, client 102 may be required to transmit a cookie in one request followed by a user name and password in an additional request.

Depending on the web site, there can be one to any number of instructions in a given instruction set. A given instruction set includes all of the necessary requests in order to login client 102 into destination site 108. The generation of the instruction set is described in more detail below in conjunction with FIGS. 7 and 8. Once the last instruction in the instruction set is transmitted to the web site, a web page is transmitted back to the user indicating that the user is logged into the web site, at process block 318. For example, if the web site is an email web site, this web page could be a display of the inbox showing the new emails for this email account.

### INSTRUCTION SET FILE GENERATION

FIG. 7 illustrates a block diagram of a proxy component in conjunction with the client and server for the generation of an instruction set for a given web site, according to one embodiment of the invention. In particular, FIG. 7 includes web browser 704 with client 102 coupled to network 106. Server 104 includes web site 214 that is coupled to proxy component 218. Server 104 is coupled to network 106. Additionally, destination site 108 that includes web server 706 is coupled to network 106. The generation of the instruction file for destination site 108 will now be described in conjunction with the block diagram of FIG. 7 and the flowchart of FIG. 8.

In particular, FIG. 8 is a flowchart illustrating the generation of a set of instructions for a given web site, according to one embodiment of the invention. In an embodiment, a user is residing on client 102 wherein web browser 704 is open. In one embodiment, the user described in conjunction with FIGS. 7 and 8 for the generation of an instruction set is an engineer or other person assisting in the development and maintenance of server 104 (hereinafter “the engineering user”).

The engineering user enters the web site address for destination site 108 in a web application served by web site 214. This web site address is transmitted to destination site 108 via proxy component 218. In an embodiment, proxy component 218 is a software application also executing on server 104. However, embodiments of the present invention are not so limited, as proxy component 218 can reside in other locations. For example, proxy component 218 could reside on the same client, another client or another server coupled to network 106. Proxy component 218 receives this web site address, at process block 802, and begins the generation of an instruction file for destination site 108. In particular, proxy component 218 creates an instruction file that includes this web site address, at process block 804. Proxy component 218 then forwards this request to destination site 108 through network 106, at process block 806.

As illustrated above in conjunction with FIG. 6, in turn, destination site 108 returns a response, which, for example, could be an initial page, a cookie and/or a redirection to another web site address. Destination site 108 transmits this response back through network 106 to server 104. In an embodiment wherein the response is a web page, a number of Uniform Resource Language (URL) addresses are included therein. In particular, a given web page typically includes a number of hyperlinks in the form of URLs, which the user can select to transfer to other web pages whose URL addresses are associated with those hyperlinks. Proxy component 218 processes the response that server 104 received from destination site 108, at process block 808.

In an embodiment, proxy component 218 modifies the data in the response from destination site 108. In one such embodiment, proxy component 218 modifies or mangles the URLs in the data to allow for subsequent saving into the instruction set file, at process block 810. In particular, the response being received back from destination site 108 includes a number of hyperlinks, which when selected can direct the user directly back to destination site 108 (without going through proxy component 218). Accordingly, in an embodiment, proxy component 218 modifies the URLs such that selection of a hyperlink within the response will cause the data to be transmitted to proxy component 218 (not going directly to a web page on destination site 108, for example). Proxy component 218 transmits the modified response from destination site 108 back to web browser 704, at process block 812. Accordingly, web browser 704 receives this modified response on client 102. For example, in the initial response, a welcome page or login page could be displayed to the user at web browser 704. Proxy component 218 also saves this data from the response from destination site 108 and adds a corresponding new instruction into the instruction set file, at process block 810.

The engineering user determines if the modified response is the “correct” web page, at process decision block 814. Although the correct web page can be defined by the engineering user to be any given web page, in an embodiment, the right web page is defined to be the web page indicating to the user that they are logged into destination site 108. For example, for email account web sites, this web page is the inbox page showing the user their new emails. If the right web page is returned to client 102, the instruction set file generation is complete, at process block 816.

However, if the engineering user desires to continue searching destination site 108 for the correct web page, the instruction set file generation continues, returning to process block 802. Accordingly, the engineering user typically selects a hyperlink, which contains a URL, from the web page returned by destination site 108 after modification by proxy component 218. Upon selection of a hyperlink, web browser 704 transmits the associated URL address as well as any other data entered by the engineering user or provided by web browser 704 back toward network 106. Examples of other types of data provided by web browser 704 includes, but is not limited to, cookies, which may be requested by destination site 108. Moreover, examples of other types of data entered by the engineering user could include login information, such as their username and password. Proxy component 218 receives this address as well as any other web site data being transmitted with the address, at process block 802. In one embodiment wherein the engineering user's username and password are transmitted to destination site 108, this login information could be transferred as the equations (1) and (2) shown below:

Username=JohnSmith (1)

Password=JohnSmithPassword (2)

In an embodiment, in order to make the instruction set file generic for all users, proxy component 218 modifies the values to which “Username” and “Password” are equal. In other words, proxy component 218 replaces the values “JohnSmith” and JohnSmithPassword” with variable names. Accordingly, during the automatic login process described above, such variable names can be replaced with the given user's actual username and password for this web site that has been stored in authentication database 208. Proxy component 218, therefore, could replace equations (1) and (2) respectively with equations (3) and (4), shown below:

Username=UserVariableName (3)

Password=PasswordVariableName (4)

wherein “UserVariableName” and “PasswordVariableName” are extracted from authentication database 208 for the current user and the given web site.

Additionally, proxy component 218 saves this web site data including the web site address along with any modifications (e.g., the usernnames and passwords) into instruction set file, at process block 804. Proxy component 218 forwards this web site data, exclusive of any modifications, to destination site 108 through network 106, at process block 806. Additionally, destination site 108 returns a response to the request from server 104, which, as described above, for example, can include web pages, a request for a cookie and/or other web site data, which is received by proxy component 218, at process block 808. As previously described, proxy component 218 can modify this web site data, at process block 810. Moreover, proxy component 218 saves a new instruction corresponding to the response from destination site 108 into the instruction set file, at process block 810.

Proxy component 218 transmits this web site data, and any modifications, back to web browser 704. The engineering user of web browser 704 determines whether the response from destination site 108 includes the “correct” web page, as described above, at process decision block 814. This recursive (repeating) process illustrated by method 800 continues until the correct web page is found. Accordingly, the generated instruction set file includes the proper requests that need to be sent to a given web site to allow a user of web site 214 to automatically login once the instruction set there is executed.

In an embodiment, such an automatic login process can be performed when a user of web site 214 selects a hyperlink to that web page. For example, returning to FIG. 4, in an embodiment, a user of web site 214 is presented with web page 402 upon logging in. The user may want to automatically log in to any one of the accounts listed without going through the typically manual log in process. Assuming that the user wants to automatically log into first email account 414, the user selects that hyperlink, which activates method 300 of FIG. 3 described above, thereby automatically logging in the user into the given web site.

In one embodiment, an instruction set for a given account is generated with the assistance of a web-based administrative interface that allows an engineering user operating on client 102 to diagnose and repair existing instruction sets stored on server 104. In particular, due to the dynamic nature of destination sites, instruction sets have to be maintained and kept current and compatible with the pages on the destination sites. In an embodiment, administration unit 216 stores log files related to the execution of the instruction sets. In an embodiment, the log files can include the errors associated with the instruction set. For example, if the destination site 108 modified its pages, the instruction set would generate an error and would be logged by administration unit 216. Accordingly, the engineering unit could remotely login into server 104 to access the log files through administration unit 216. Based on these log files, the engineering user may need to regenerate the instruction set for a given destination site 108. As described, there is a separation between the engineering user and the secured data, such as the authentication data stored in authentication database 208 within server 104.

### AUTOMATIC READ

In addition to the generation of an instruction file, a user, such as an engineer or other person assisting in the development and maintenance of web site 214 (hereinafter “the engineering user”), assists in the generation of a rule file for the automatic read of portions of web pages of those web sites stored in site database 210. As will be described in more detail below, the rule file generated for an automatic read allows for the extraction of relevant data elements from data source pages from destination site 108. In an embodiment, this automatic read can be executed in conjunction with the automatic login process, wherein the automatic read executes subsequent to the automatic login process. However, embodiments of the present invention are not so limited, as the automatic read and automatic login can be executed independent of one another.

FIG. 9 illustrates a block diagram of a monitor screen for client 102 during the generation of a rule file employed during automatic (auto) reads, according to one embodiment of the invention. As shown, FIG. 9 illustrates monitor screen 902 that includes web browser screen 904 and rule application screen 906. Monitor screen 902 is coupled to client 102 (not shown) and is running a web browser application, such as web browser 704, in web browser screen 904 and a rule application in rule application screen 906. In particular, the web browser application is employed to traverse the various Internet web sites receiving different web pages from such sites, as is known in the art. Moreover, in an embodiment, the rules application is used in the generation of a rules file to allow for the auto reads of the different web sites that users of web site 214 incorporate into their personalized web pages at web site 214. This auto read mechanism is described in more detail below in conjunction with FIG. 12.

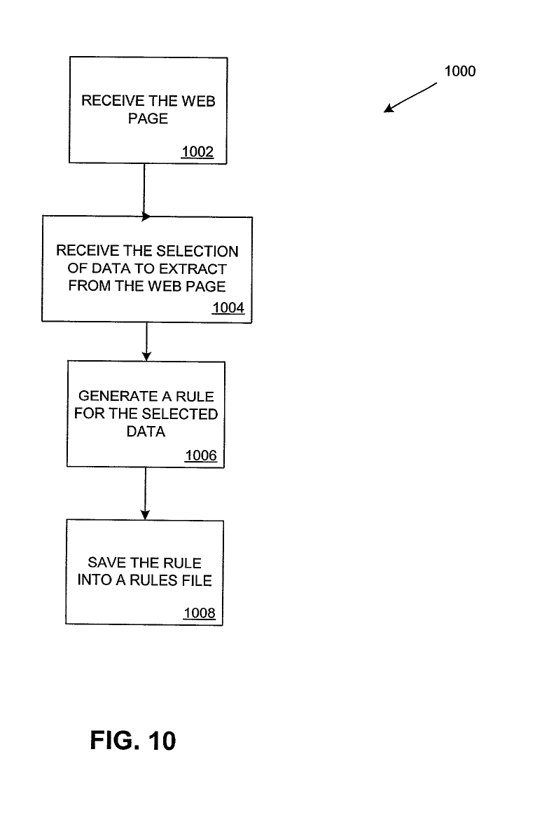

The generation of the rules file will now be described in conjunction with the block diagram of FIG. 9 and the flowchart of FIG. 10. In particular, FIG. 10 is a flowchart illustrating the generation of a rules file for a given web site, according to one embodiment of the invention. Method 1000 of FIG. 10 commences with the receipt of a web page, at process block 1002. Although such a web page can be received from different locations and in different ways, in an embodiment, the engineering user loads the web page into the rules application. In particular, the engineering user can traverse the Internet using the web browser application to locate the web page for which a rules file is going to be generated.

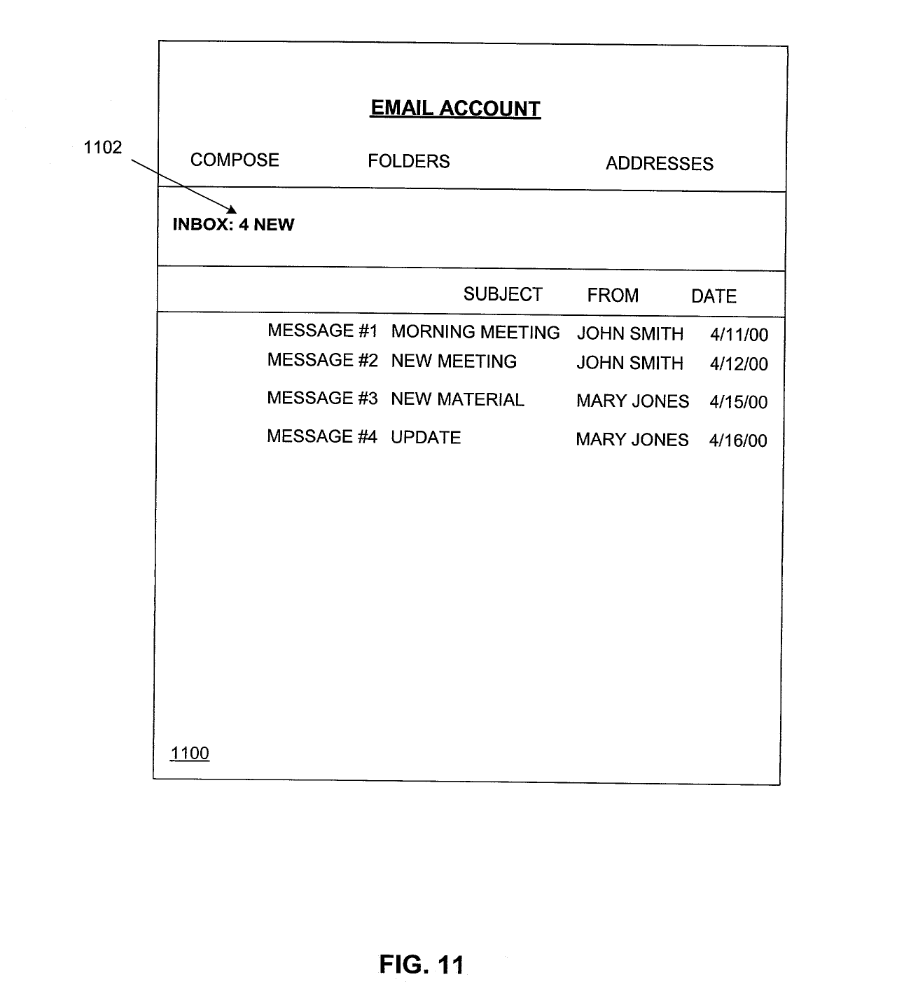

Additionally, the selection of the data to extract from the web page is also received, at process block 1004. In an embodiment, the rules application receives this selection of the data to extract as input from the engineering user. FIG. 11 illustrates a web page from which data can be extracted, according to one embodiment of the invention. As shown, FIG. 11 includes web page 1100 that illustrates an inbox for an email account for a given user of web site 214. Among the data presented on web page 1100 is inbox number 1102, which is the number of new emails located in the current email account.

Assuming that the data to be extracted includes inbox number 1102, using the rules application, the engineering user highlights this value and selects a button associated with the rules application. The rules application generates a rule for the selected data, at process block 1006. In particular, the rules application generates a rule that sets forth the location of the selected data to be extracted within the web page. In one embodiment, the rules application determines the row and column as well as the number of characters to extract using extraction techniques, which are known in the art. In an embodiment, the rules application generates rules for extraction based on surrounding data. For example, for inbox number 1102, the rules application could set up a rule to extract inbox number 1102 by locating the word “INBOX:” and extract the next two characters. The rules application saves this rule regarding the location of the selected data into a rules file, at process block 1008.

Method 1000 can continue as a recursive (recurring) process until the engineering user has caused the generation of the rules for all of the data that needs to be extracted. Accordingly, the rules application can locate and extract one to any number of portions of data from a given web page. Although the data can be stored in different ways, in an embodiment, the rules application generates a rule for each portion of data to be located and stores the different rules for a given web page into a rules file. Additionally, in an embodiment, the rules file and instruction file for a given web site and associated web pages can be incorporated into one file.

Because, for a given email web site, the interfaces of the web pages are uniform across different users, a generic rules file for a given web page, once generated, is applicable to different users of web site 214. Moreover, in an embodiment, the engineering user can generate both the instruction set file and the rules file concurrently. For example, once a given web page is returned by a particular account web site (e.g., an email account web site) during the generation of the instruction file and is displayed in web browser screen 904, the engineering user can load the web page into rules application screen 906 and can generate a rules file for this page employing the process described above in conjunction with FIG. 10. However, embodiments of the present invention are not so limited as the rules file can be generated separately from the instruction set file.

Returning to FIG. 4, the rules files generated for different web pages allow for the automatic read of such web pages, thereby displaying relevant portions of these different web pages once the user is logged into web site 214. In one embodiment, these relevant portions of the different web pages are presented to the user on a single web page, as illustrated by web page 402 of FIG. 4.

FIG. 12 is a flowchart illustrating the incorporation of the rules files, according to one embodiment of the invention. In particular, method 1200 of FIG. 12 will be described in conjunction with web page 402 of FIG. 4. Method 1200 commences with the receipt of a request for login into web site 214 from a user thereof, at process block 1202. In an embodiment, such a request is received as the user provides their username and password for web site 214. Accordingly, an automatic login process, as illustrated in method 300 of FIG. 3, is performed for each of the user's online accounts that are incorporated into web site 214, at process block 1204. For example, for web page 402, login unit 206 will automatically login to the web sites associated with first email account 414, second email account 416, first investment account 420, second investment account 422, first bank account 424 and second bank account 426.

Moreover, the portions of data to be displayed to the user upon their logging in is extracted from given web pages for each of these online account web sites. In an embodiment, the portions of data to be extracted are based on the rules files previously generated for a given web site. For example, web page 402 includes portions of web pages for each of these different online account web sites. In particular, the number of new emails (3 and 5, respectively) for first email account 414 and second email account 416 has been extracted from web pages from each of these accounts, using the rules files for these two different web sites. Similarly, the accounts numbers (1111111, 1111112, 2222222 and 2222223, respectively) for first investment account 420, second investment account 422, first bank account 424 and second bank account 426 have been extracted from web pages for each of these accounts, using rules files form these four different web sites. At process block 1208, the logged on home page for web site 214 is displayed to the user, which includes the aggregated information. An example of such a logged on home page is web page 402. Accordingly, the user is able to see their online accounts in a condensed format that includes portions of relevant and possibly dynamic data (e.g., number of new emails).

Moreover, in an embodiment, these portions of data can be updated. In one embodiment, a periodic update is performed. In an embodiment, an update is performed when a user of web site 214 selects a button, such as a refresh button, to obtain updates to these portions of data. For example, the number of new emails received in a given online email account can periodically change. To automatically retrieve and display the updated information, an automatic login process is re-executed to receive the updated web page and is followed by a new extraction of the portions of data using the rules file for the given web site.

While different embodiments have been described that can be practiced separately, in one embodiment, the different embodiments are used in conjunction with each other. To help illustrate, aggregation unit 220 can be employed to perform the auto login process using the associated instruction set. Additionally, aggregation unit 220 can uses the rules file associated with different pages of the account to extract data there from.

Memory 204 includes a machine-readable medium on which is stored a set of instructions (i.e., software) embodying any one, or all, of the methodologies described herein. Software can reside, completely or at least partially, within memory 204 and/or within processing unit 202. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Thus, a method and apparatus for instruction file set generation for online account aggregation have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A computer-implemented method comprising:
receiving a request for logging into an account on a web site from a web browser application;
recursively performing the following until a user is logged into the account for the web site:
saving the request into an instruction set file;
transmitting the request for logging into the web site to a server that includes the web site;
receiving a response from the web site; and
transmitting a request that is in response to the response from the web site.

2. The computer-implemented method of claim 1, wherein recursively performing the following comprises modifying at least a portion of the request prior to saving the request into the instruction set file.

3. The computer-implemented method of claim 2, wherein the modifying of the at least a portion of the request comprises replacing a set of credentials for the account with generic variable names.

4. The computer-implemented method of claim 1, wherein the recursively performing the following comprises forwarding the response to the web browser with modifications to the addresses within the response.

5. An apparatus comprising:
a browser to login into an account on a web site, the web site stored on a server; and
a proxy component coupled between the browser and the server, wherein the proxy component is to intercept communications between the browser and the web site, wherein the proxy component is to store the communications in an instruction set file.

6. The apparatus of claim 5, wherein the communications comprise a number of requests by the browser.

7. The apparatus of claim 5, wherein the proxy component is to modify at least a portion of the communications for storage into the instruction set file.

8. The apparatus of claim 7, wherein the modifications include modifying addresses within the portion of the communications.

9. The apparatus of claim 8, wherein the proxy component forwards communications from the web site to the browser with the modifications.

10. A system comprising:
a server coupled to a network, the server comprising:
a site database to store at least one entry, wherein the at least one entry includes a web site name and web site address;
an instruction set database having at least one instruction set, wherein the at least one instruction set is to include instructions to login into a web site;
an authentication database having at least one user entry, wherein the at least one user entry is to include authentication data for an account for the web site; and
a login unit coupled to the site database, the instruction set database and the authentication database, the login unit to receive a request to login a user into an account on a web site independent of user interaction, the login unit to incorporate the web site address from the corresponding entry for the web site in the site database into the instruction set that corresponds to the web site, the login unit to incorporate the authentication data in the at least one user entry that corresponds to the at least one instruction set in the instruction set database, wherein the login unit is to store log data related to logging in the user into the web site; and
an administrative client coupled to the server through the network, the administrative client to retrieve the log data from the server.

11. The system of claim 10, wherein the server comprises a proxy component to generate an updated instruction set that corresponds to the web site upon determining that an error occurred while logging in the user based on the log data.

12. The system of claim 11, wherein the proxy component is to generate the updated instruction set based on intercepting communications between a browser in the administrative client and the web site.

13. The system of claim 12, wherein the proxy component is to modify at least a portion of the communications for storage into the instruction set file.

14. The system of claim 13, wherein the modifications include modifying addresses within the portion of the communications.

15. The system of claim 14, wherein the modifying of the addresses causes the browser to communicate to the web site through the proxy component.

16. The system of claim 14, wherein the proxy component is to forward communications from the web site to the browser with the modifications.

17. A machine-readable medium that provides instructions, which when executed by a machine, cause said machine to perform operations comprising:
receiving a request for logging into an account on a web site from a web browser application;
recursively performing the following until a user is logged into the account for the web site:
saving the request into an instruction set file;
transmitting the request for logging into the web site to a server that includes the web site;
receiving a response from the web site; and
transmitting a request that is in response to the response from the web site.

18. The machine-readable medium of claim 17, wherein recursively performing the following comprises modifying at least a portion of the request prior to saving the request into the instruction set file.

19. The machine-readable medium of claim 18, wherein the modifying of the at least a portion of the request comprises replacing a set of credentials for the account with generic variable names.

20. The machine-readable medium of claim 17, wherein the recursively performing the following comprises forwarding the response to the web browser with modifications to the addresses within the response.
